(19) United States
(12) Patent Application Publication
(10) Pub. No.: US 2021/0080878 A1
(43) Pub. Date: Mar. 18, 2021

(54) FIXING DEVICE

(71) Applicant: BROTHER KOGYO KABUSHIKI KAISHA, Nagoya-shi (JP)

(72) Inventors: Hiroshi HANDA, Inazawa-shi (JP); Kenji TAKEUCHI, Nagoya-shi (JP)

(73) Assignee: BROTHER KOGYO KABUSHIKI KAISHA, Nagoya-shi (JP)

(21) Appl. No.: 17/034,106

(22) Filed: Sep. 28, 2020

Related U.S. Application Data
(63) Continuation of application No. PCT/JP2019/012759, filed on Mar. 26, 2019.

(30) Foreign Application Priority Data
Mar. 28, 2018 (JP) 2018-063207

(51) Int. Cl. G03G 15/20

(52) U.S. Cl. CPC G03G 15/2028; G03G 2215/2019; G03G 15/2064

(57) ABSTRACT

A fixing device according to the present disclosure includes a heater, a rotating member heated by the heater, an endless belt, a nip forming member, and a sliding sheet. The nip forming member forms a nip portion by nipping the endless belt between the nip forming member and the rotating member. The sliding sheet has a first portion nipped between the endless belt and the nip forming member and a second portion extending from the first portion. The sliding sheet has higher flexural rigidity than the endless belt. The second portion has a bent portion bent so as to contact an inner circumferential surface of the endless belt. The bent portion configured to urge, in a direction directed from an inner side toward an outer side of the endless belt, a portion of the endless belt positioned downstream of the nip portion in the moving direction.

### CROSS REFERENCE TO RELATED APPLICATIONS

The present application is a continuation application of International Application No. PCT/JP2019/012759, filed on Mar. 26, 2019, which claims priority to Japanese Patent Application No. 2018-063207, filed on Mar. 28, 2018. The contents of these applications are incorporated by in their entirety.

### BACKGROUND

The present disclosure relates to a fixing device heat-fixing a developer image on a sheet, which has been transferred to the sheet.

There is conventionally known a fixing device including a halogen lamp, a heating roll, an endless belt, a pressure member, a film-shaped sheet member, and so on. The pressure member is disposed inside the endless belt, pressing the endless belt against the surface of the heating roll. The film-shaped sheet member is interposed between the endless belt and the heating member. In such fixing device, the endless belt is driven to rotate with rotation of the heating roll.

### SUMMARY

Incidentally, when the endless belt comes out of a nip portion between the heating roll and the pressure member, the motion of the endless belt may become unstable due to flapping or the like of a part coming out of the nip portion. When this happens, unnecessary stress is applied to the endless belt and fatigue is accumulated, which may reduce durability of the endless belt.

In view of the above, an object of the present disclosure is to provide a fixing device capable of improving durability of the endless belt.

In order to achieve the above object, a fixing device according to the present disclosure includes a heater, a rotating member heated by the heater, an endless belt, a nip forming member, and a sliding sheet. The nip forming member forms a nip portion by nipping the endless belt between the nip forming member and the rotating member. The sliding sheet has a first portion nipped between the endless belt and the nip forming member.

The sliding sheet includes a second portion extending from downstream of the first portion in a moving direction of the endless belt in the nip portion. Flexural rigidity of the sliding sheet is higher than flexural rigidity of the endless belt.

The second portion has a bent portion bent so as to contact an inner circumferential surface of the endless belt.

The bent portion configured to urge, in a direction directed from an inner side toward an outer side of the endless belt, a portion of the endless belt positioned downstream of the nip portion in the moving direction.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a cross-sectional view of an image forming apparatus including a fixing device according to the disclosure.

FIG. 2 is a cross-sectional view of the fixing device.

FIG. 3 is a view of the fixing device seen from a downstream side in a moving direction of an endless belt in a nip portion.

FIG. 4A is a perspective view of a facing member seen from the downstream side in the moving direction of the endless belt in the nip portion and FIG. 4B is a perspective view thereof seen from an upstream side.

FIG. 5A is a perspective view of a sliding sheet according to a first embodiment, FIG. 5B is an X-X cross-sectional view of FIG. 5A, and FIG. 5C is a Y-Y cross-sectional view of FIG. 5A.

FIGS. 6A and 6B are enlarged cross-sectional views of the fixing device, in which FIG. 6A is a view showing the vicinity of a center bent portion and FIG. 6B is a view showing the vicinity of an end-part bent portion.

FIG. 7 is a perspective view of a sliding sheet according to a second embodiment.

FIG. 8 is a perspective view of a sliding sheet according to a third embodiment.

FIG. 9A is a view of the sliding sheet according to the third embodiment seen from the downstream side in the moving direction of the endless belt in the nip portion and FIG. 9B is a view showing a state where the sliding sheet is nipped between a support member and the facing member.

FIG. 10 is a perspective view of a sliding sheet according to a fourth embodiment.

FIG. 11A is a perspective view of a sliding sheet according to a fifth embodiment and FIG. 11B is a Z-Z cross-sectional view of FIG. 11A.

### EMBODIMENT

Hereinafter, a first embodiment of the disclosure will be explained in detail with reference to the drawings appropriately.

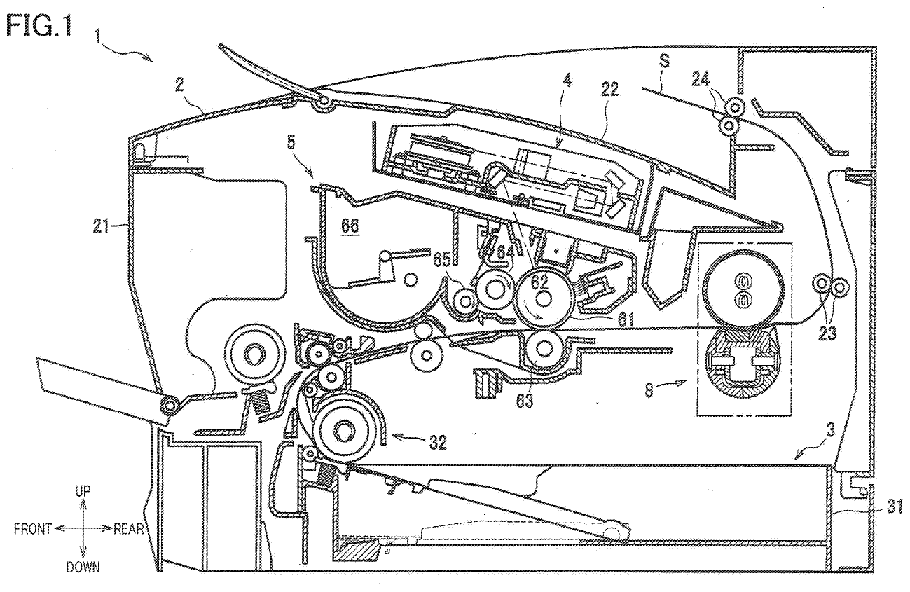

As illustrated in FIG. 1, a fixing device 8 according to the embodiment is used for an image forming apparatus 1 such as a laser printer. The image forming apparatus 1 includes a housing 2, a sheet supplier 3, an exposing device 4, a developer image forming portion 5, and the fixing device 8.

The sheet supplier 3 is provided at a lower portion of the housing 2, including a sheet tray 31 for accommodating sheets S such as paper and a sheet supply mechanism 32. The sheet S in the sheet tray 31 is supplied to the developer image forming portion 5 by the sheet supply mechanism 32.

The exposing device 4 is disposed at an upper portion of the housing 2, including a not-illustrated light source device, a polygon mirror, a lens, a reflective mirror, and so on illustrated without reference numerals. The exposing device 4 exposes a surface of a photoconductor drum 61 by scanning the surface of the photoconductor drum 61 at high speed with a light beam (see a dashed-dotted line) emitted from the light source device based on image data.

The developer image forming portion 5 is disposed below the exposing device 4. The developer image forming portion 5 is configured as a process cartridge so as to be attached to and removed from the housing 2 through an opening formed when opening a front cover 21 provided on the front of the housing 2. The developer image forming portion 5 includes the photoconductor drum 61, a charging unit 62, a transfer roller 63, a developing roller 64, a supply roller 65, and a developer container 66 containing a developer formed of dry toner.

The developer image forming portion 5 uniformly charges the surface of the photoconductor drum 61 by the charging unit 62. After that, the surface of the photoconductor drum 61 is exposed by the light beam emitted from the exposing device 4 to thereby form an electrostatic latent image on the surface of the photoconductor drum 61 based on imaged data. The developer image forming portion 5 supplies a developer in the developer container 66 to the developing roller 64 through the supply roller 65.

Then, the developer image forming portion 5 supplies the developer on the developing roller 64 to the electrostatic latent image formed on the photoconductor drum 61. This visualizes the electrostatic latent image, and a developer image is formed on the photoconductor drum 61. After that, the developer image forming portion 5 conveys the sheet S supplied from the sheet supplier 3 between the photoconductor drum 61 and the transfer roller 63, so that the developer image on the photoconductor drum 61 is transferred to the sheet S.

The fixing device 8 is disposed behind the developer image forming portion 5. The details of the fixing device 8 will be described later. The fixing device 8 heat-fixes the developer image on the sheet S while the sheet S to which the developer image is transferred is passing through the fixing device 8. The image forming apparatus 1 discharges the sheet S on which the developer image is heat-fixed onto a paper output tray 22 at the outside of the housing 2 by a conveying roller 23 and an output roller 24.

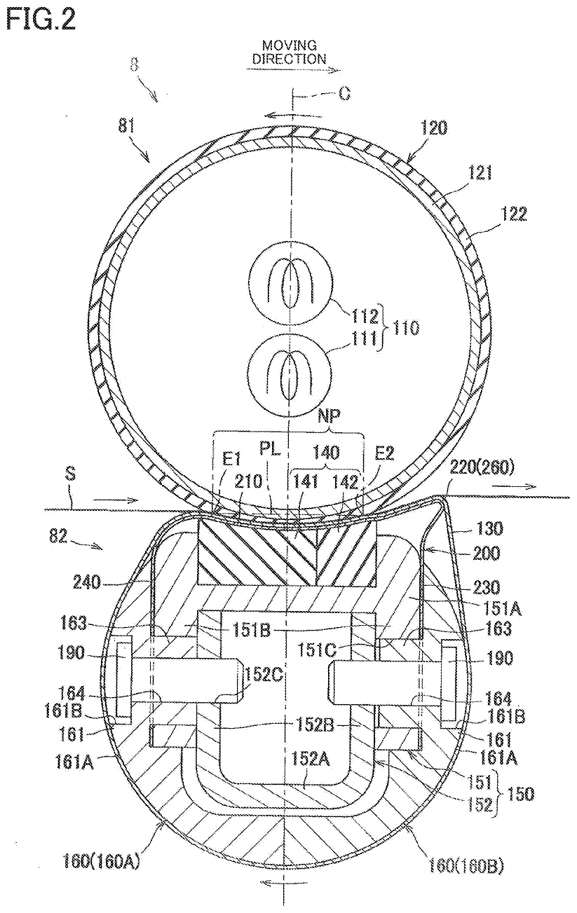

As illustrated in FIG. 2, the fixing device 8 includes a heating unit 81 and a pressure unit 82. One of the heating unit 81 and the pressure unit 82 is pressed to the other of the heating unit 81 and the pressure unit 82 by a not-illustrated pressing mechanism.

The heating unit 81 includes a heater 110. The heating unit 81 includes a rotating member 120. The pressure unit 82 includes an endless belt 130. The pressure unit 82 includes a nip forming member 140. The pressure unit 82 includes a support member 150. The pressure unit 82 includes a facing member 160. The pressure unit 82 includes a sliding sheet 200. In the following description, a width direction of the endless belt 130 is referred to as merely a “width direction”. The width direction is a direction parallel to a direction in which a rotation axis line of the rotating member 120 extends.

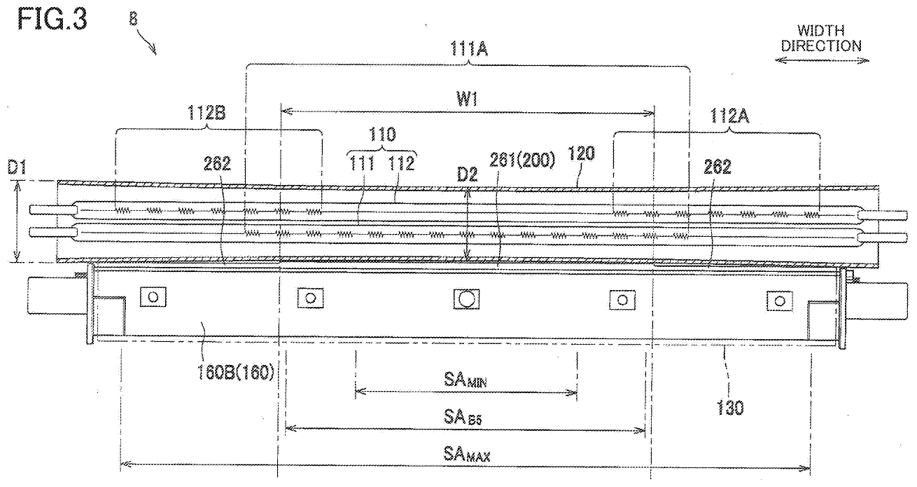

The heater 110 is a halogen lamp emitting light and generating heat when energized, which heats the rotating member 120 by radiant heat. The heater 110 is disposed so as to extend through the inside of the rotating member 120 along the rotation axis line of the rotating member 120. The heater 110 includes a first heater 111 and a second heater 112. As illustrated in FIG. 3, the first heater 111 includes a first heating portion 111A heating a center portion of the rotating member 120 in the width direction. The second heater 112 includes a pair of second heating portions 112A, 112B heating end portions of the rotating member 120 in the width direction.

The rotating member 120 is a cylindrical roller elongated in the width direction, which is heated by the heater 110. In the rotating member 120, an outer diameter of each of ends of the rotating member 120 in the width direction is greater than an outer diameter of a center of the rotating member 120 in the width direction. Specifically, the rotating member 120 has a concave shape in which an outer diameter D1 of each of the ends of the rotating member 120 is greater than an outer diameter D2 of the center of the rotating member 120, and the outer diameter is gradually increased from the center of the rotating member 120 toward each of the ends of the rotating member 120.

Returning to FIG. 2, the rotating member 120 includes a blank tube 121 formed of metal or the like and an elastic layer 122 covering an outer circumferential surface of the blank tube 121. The rotating member 120 is supported by a not-illustrated frame of the fixing device 8 so as to rotate, which is driven to rotate counterclockwise in FIG. 2 when a driving force is inputted from a not-illustrated motor provided in the housing 2 of the image forming apparatus 1.

The endless belt 130 is a long tubular member, having flexibility. The endless belt 130 includes a base material formed of metal, resin, or the like and a release layer covering an outer circumferential surface of the base material, though not illustrated. The endless belt 130 is driven to rotate clockwise in FIG. 2 by friction with respect to the rotating member 120 or the sheet S when the rotating member 120 rotates. Lubricant such as grease is applied to an inner circumferential surface of the endless belt 130.

The nip forming member 140 is a member for forming a nip portion NP by nipping the endless belt 130 between the nip forming member 140 and the rotating member 120. The nip forming member 140 has a first elastic body 141. The nip forming member 140 has a second elastic body 142. The first elastic body 141 and the second elastic body 142 are formed in a rectangular parallelepiped shape elongated in the width direction. Since the first elastic body 141 and the second elastic body 142 are formed of an elastic material such as rubber having heat resistance, the first elastic body 141 and the second elastic body 142 can be elastically deformed. The second elastic body 142 is harder than the first elastic body 141.

The first elastic body 141 and the second elastic body 142 are disposed inside the endless belt 130. The first elastic body 141 and the second elastic body 142 are arranged so as to be aligned in a moving direction of the endless belt 130 in the nip portion NP. Specifically, the first elastic body 141 is disposed on an upstream side and the second elastic body 142 is disposed on a downstream side in the moving direction of the endless belt 130 in the nip portion NP.

In the following description, the moving direction of the endless belt 130 in the nip portion NP is referred to as merely a “moving direction”. The moving direction is a direction parallel to a plane PL passing an upstream end E1 and a downstream end E2 in the nip portion NP in a circumferential direction of the endless belt 130.

The support member 150 is a member supporting the nip forming member 140 and is formed to be long in the width direction. The support member 150 is formed approximately symmetrically in the moving direction with respect to a center C in the moving direction. The support member 150 includes a holder 151. The support member 150 includes a stay 152.

The holder 151 is a member holding the nip forming member 140 and is made of resin or the like having heat resistance. The holder 151 is disposed inside the endless belt 130. The holder 151 includes a holder body 151A holding the nip forming member 140 and a pair of side wall portions 151B extending in a direction away from the rotating member 120 from both ends of the holder body 151A in the moving direction.

The stay 152 is a member supporting the nip forming member 140 through the holder 151, which is disposed so as to extend through the inside of the endless belt 130. The stay 152 supports a load received by the nip forming member 140 from the rotating member 120 when the heating unit 81 and the pressure unit 82 are pressed. That is why the stay 152 is formed by bending a metal plate having a relatively high rigidity.

The stay 152 has a base portion 152A extending in the moving direction and a pair of leg portions 152B extending in a direction coming close to the rotating member 120 from both ends of the base portion 152A in the moving direction. The pair of leg portions 152B are disposed between the pair of side wall portions 151B of the holder 151. The stay 152 supports the nip forming member 140 through the holder body 151A.

The facing member 160 is a belt guide for guiding the endless belt 130 and is formed to be long in the width direction. The facing member 160 is disposed inside the endless belt 130.

The facing member 160 includes an upstream facing member 160A disposed on the upstream side from the center C of the support member 150 in the moving direction. The facing member 160 includes a downstream facing member 160B disposed on the downstream side from the center C of the support member 150 in the moving direction.

The downstream facing member 160B has a guide portion 161. The downstream facing member 160B has protruding portions 163.

The guide portion 161 is a portion formed in an arc shape, an outer circumferential surface of which is a guide surface 161A. The guide surface 161A contacts the inner circumferential surface of the endless belt 130 to guide the endless belt 130 coming from between the rotating member 120 and the nip forming member 140 toward the guide surface 161A of the upstream facing member 160A. A portion of the guide portion 161 disposed downstream of the nip portion NP in the moving direction faces a portion of the support member 150 positioned downstream of the support member 150 in the moving direction.

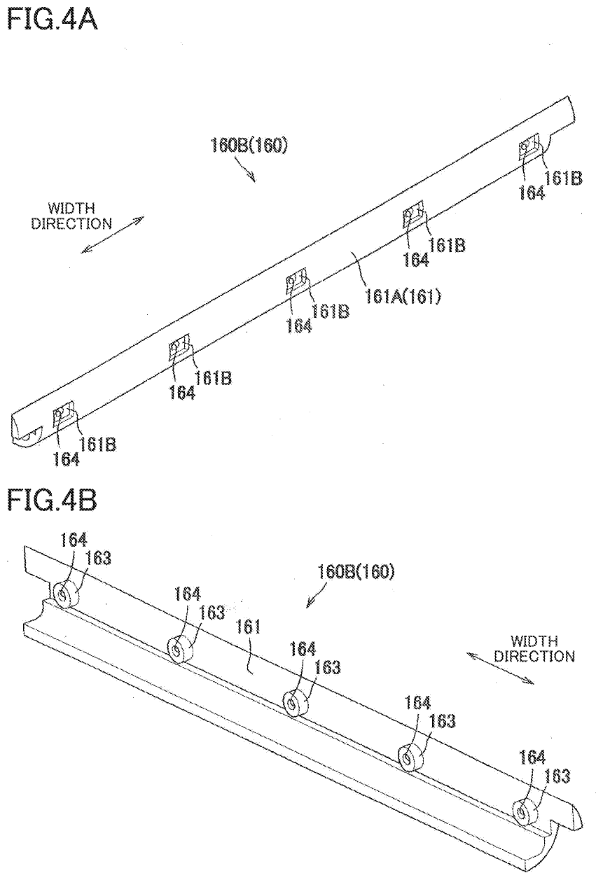

The protruding portions 163 protrude from a portion of the guide portion 161 facing the support member 150 in the moving direction toward the support member 150. In other words, the protruding portions 163 protrude toward an upstream side in the moving direction from the guide portion 161. As illustrated in FIG. 4A, 4B, each of the protruding portions 163 has a cylindrical shape, and a penetrating through hole 164 is formed inside the cylindrical shape of the protruding portion 163. A plurality of protruding portions 163 are formed on the downstream facing member 160B. Specifically, five protruding portions 163 are provided. The five protruding portions 163 are arranged so as to be aligned in parallel in the width direction. Intervals between adjacent each two of the protruding portions 163 are approximately equal.

As illustrated in FIG. 2, the upstream facing member 160A is formed approximately symmetrically to the downstream facing member 160B in the moving direction except that the position is reversed between the upstream side and the downstream side. The guide surface 161A of the upstream facing member 160A guides the endless belt 130 toward a position between the rotating member 120 and the nip forming member 140.

The facing member 160 is fixed to the support member 150 by fastening members 190 such as screws penetrating through the protruding portions 163. Specifically, the facing member 160 is fixed to the leg portions 152B of the stay 152 by the fastening members 190. Holder holes 151C with which the protruding portions 163 are engaged are formed in the side wall portions 151B of the holder 151, and stay holes 152C to which the fastening members 190 are screwed are formed in the leg portions 152B of the stay 152. In the guide portion 161, recesses 161B into which head portions of the fastening portions 190 can be inserted are formed for avoiding interference between the head portions of the fastening members 190 and the endless belt 130.

The sliding sheet 200 is disposed for reducing sliding resistance between the endless belt 130 and the nip forming member 140. The sliding sheet 200 is a sheet made of resin containing polyimide as an example. The sliding sheet 200 is formed so that the dynamic friction force with respect to the endless belt 130 becomes smaller than the dynamic friction force of the nip forming member 140 with respect to the endless belt 130.

The sliding sheet 200 has a first portion 210. The sliding sheet 200 includes a second portion 220. The sliding sheet 200 has a third portion 230. The sliding sheet has a fourth portion 240.

The first portion 210 is a portion of the sliding sheet 200 nipped between the endless belt 130 and the nip forming member 140.

The second portion 220 is a portion extending from a downstream end of the first portion 210 in the moving direction. In the embodiment, the second portion 220 has a bent portion 260 bent in an approximately U-shape so as to contact the inner circumferential surface of the endless belt 130. The bent portion 260 is bent so as to protrude toward a downstream side in the moving direction and an upper side of the endless belt 130 where the rotating member 120 is disposed (upper right oblique side in FIG. 2).

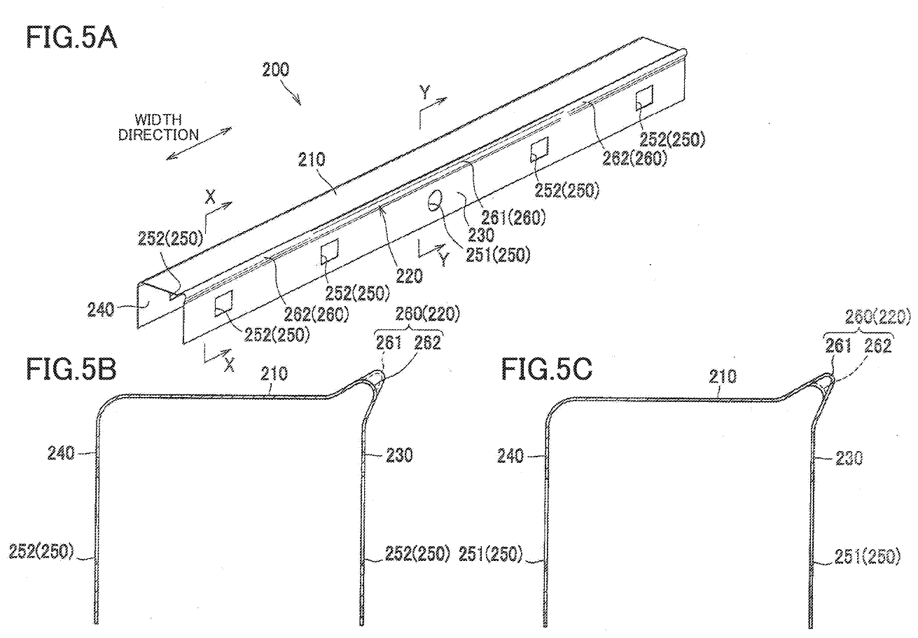

As illustrated in FIG. 5A, the bent portion 260 extends from one end to the other end of the second portion 220 in the width direction. That is, the entire second portion 220 corresponds to the bent portion 260 contacting the inner circumferential surface of the endless belt 130. The bent portion 260 includes a center bent portion 261 and a pair of end-part bent portions 262. The center bent portion 261 is positioned at a center portion of the second portion 220 in the width direction. The pair of end-part bent portions 262 are positioned at both end portions of the second portion 220 in the width direction. The pair of end-part bent portions 262 are disposed adjacent to both ends of the center bent portion 261 in the width direction.

As illustrated in FIG. 5B, C, a protruding amount of the center bent portion 261 is greater than a protruding amount of each of the end-part bent portions 262 in the bent portion 260. The sliding sheet 200 having the center bent portion 261 and the pair of end-part bent portions 262 with different protruding amounts can be formed by, for example, embossing a rectangular sheet.

As illustrated in FIG. 2, the third portion 230 extends from an end of the second portion 220 in the direction away from the rotating member 120. In other words, the third portion 230 extends from the end of the second portion 220 toward a position between the support member 150 and the facing member 160. Specifically, the third portion 230 extends from the end of the second portion 220 toward a position between the holder 151 and the guide portion 161 of the downstream facing member 160B.

The fourth portion 240 extends from an upstream end of the first portion 210 in the moving direction in the direction away from the rotating member 120. In other words, the fourth portion 240 extends from the upstream end of the first portion 210 toward a position between the support member 150 and the facing portion 160. Specifically, the fourth portion 240 extends from the upstream end of the first portion 210 toward a position between the holder 151 and the guide portion 161 of the upstream facing member 160A.

As illustrated in FIG. 5A, the third portion 230 and the fourth portion 240 have plural holes 250 through which the protruding portions 163 (see FIG. 4 B) of the facing member 160 penetrate. Five holes 250 are provided so as to correspond to the protruding portions 163, and the holes 250 are aligned in parallel in the width direction.

A hole 251 disposed at a center portion of the sliding sheet 200 in the width direction has a circular shape with a diameter approximately the same as an outer diameter of a first protruding portion 163A. Holes 252 disposed on both sides of the hole 251 in the width direction have a rectangular shape with a longer length in the width direction than the outer diameter of the protruding portions 163. As the protruding portions 163 can move along the width direction in the holes 252 in a state of penetrating though the holes 252, effects exerted when the support member 150 or the facing member 160 is thermally expanded in the width direction can be absorbed by the holes 252.

Returning to FIG. 2, the third portion 230 is nipped between the support member 150 and the facing member 160. The fourth portion 240 is nipped between the support member 150 and the facing member 160. Specifically, the third portion 230 and the fourth portion 240 are nipped between the guide portion 161 of the facing member 160 and the side wall portion 151B of the holder 151.

As illustrated in FIG. 3, a center portion in the width direction of the sliding sheet 200 including the center bent portion 261 is disposed in an area SA_{MAX} in the width direction. The area SA_{MAX} is an area where the sheet S with the maximum size on which heat-fixing can be executed by the fixing device 8 passes. Specifically, the center bent portion 261 is disposed such that one end of the center bent portion 261 in the width direction is positioned on an inner side of one end in the width direction of the sheet S with the maximum size in the width direction. The center bent portion 261 is disposed such that the other end of the center bent portion 261 in the width direction is positioned on an inner side of the other end in the width direction of the sheet S with the maximum size in the width direction.

The center portion in the width direction of the sliding sheet 200 extends in a range overlaying an entire area SA_{MIN} in the width direction. The area SA_{MIN} is an area where the sheet S with the minimum size on which heat-fixing can be executed by the fixing device 8 passes. Specifically, the center bent portion 261 extends such that the one end of the center bent portion 261 in the width direction is positioned on an outer side of one end in the width direction of the sheet S with the minimum size in the width direction. The center bent portion 261 is disposed such that the other end of the center bent portion 261 in the width direction is positioned on an outer side of the other end in the width direction of the sheet S with the minimum size in the width direction. In other words, the pair of end-part bent portions 262 are disposed in areas apart from the entire area SA_{MIN} in the width direction.

It is preferable that the center bent portion 261 extends in a range overlaying an entire area where the sheets S with lengths in the width direction of which are equal to or less than a prescribed length pass in the sheets S on which heat-fixing can be executed by the fixing device 8 in the width direction. In the embodiment, the center bent portion 261 extends in a range overlaying an entire area SA_{B5} in the width direction where a sheet S with a B5 size passes as an example. That is, the center bent portion 261 extends such that the one end of the center bent portion 261 in the width direction is positioned on an outer side of one end in the width direction of the sheet S with the B5 size in the width direction. The bent portion 261 extends such that the other end of the center bent portion 261 in the width direction is positioned on an outer side of the other end in the width direction of the sheet S with the B5 size in the width direction.

The center portion in the width direction of the sliding sheet 200 is disposed between one end to the other end of the first heating portion 111A in the width direction. Specifically, the center bent portion 261 is disposed such that the one end of the center bent portion 261 in the width direction is positioned on an inner side of the one end in the width direction of the first heating portion 111A in the width direction. The center bent portion 261 is disposed such that the other end of the center bent portion 261 in the width direction is positioned on an inner side of the other end in the width direction of the first heating portion 111A in the width direction. It is preferable that the center bent portion 261 is disposed in approximately the same range as the first heating portion 111A in the width direction.

In the embodiment, the center bent portion 261 is disposed such that the one end of the center bent portion 261 in the width direction is positioned on an outer side of an inner end in the width direction of the second heating portion 112A in the width direction. The center bent portion 261 is disposed such that the other end of the center bent portion 261 in the width direction is positioned on an outer side of an inner end in the width direction of the second heating portion 112B in the width direction. That is, the center bent portion 261 is disposed over a range from an inner end part in the width direction of the second heating portion 112A to an inner end part in the width direction of the second heating portion 112B in the width direction. In other words, the one end of the center bent portion 261 in the width direction is disposed at a position overlapping both of the first heating portion 111A and the second heating portion 112A in the width direction. The other end of the center bent portion 261 in the width direction is disposed at a position overlapping both of the first heating portion 111A and the second heating portion 112B in the width direction.

The sliding sheet 200 has higher flexural rigidity than flexural rigidity of the endless belt 130. The flexural rigidity of the sliding sheet 200 is determined by using flexural rigidity in the first portion 210 as a reference. In order to increase the flexural rigidity of the sliding sheet 200 to be higher than the flexural rigidity of the endless belt 130, for example, a material having a higher Young's modulus than that of the endless belt 130 is used as a material for the sliding sheet 200 to realize the high flexural rigidity. Additionally, the high flexural rigidity can be realized by increasing a thickness of the sliding sheet 200 to be greater than a thickness of the endless belt 130. It is further possible to make the sliding sheet 200 multilayered to realize the above.

In the embodiment, the sliding sheet 200 is configured such that the first portion 210 is held by being nipped between the endless belt 130 and the nip forming member 140 and that the third portion 230 is held by being nipped between the support member 150 and the facing member 160. Accordingly, substantial rigidity of the bent portion 260 between the first portion 210 and the third portion 230 (the second portion 220) is further increased.

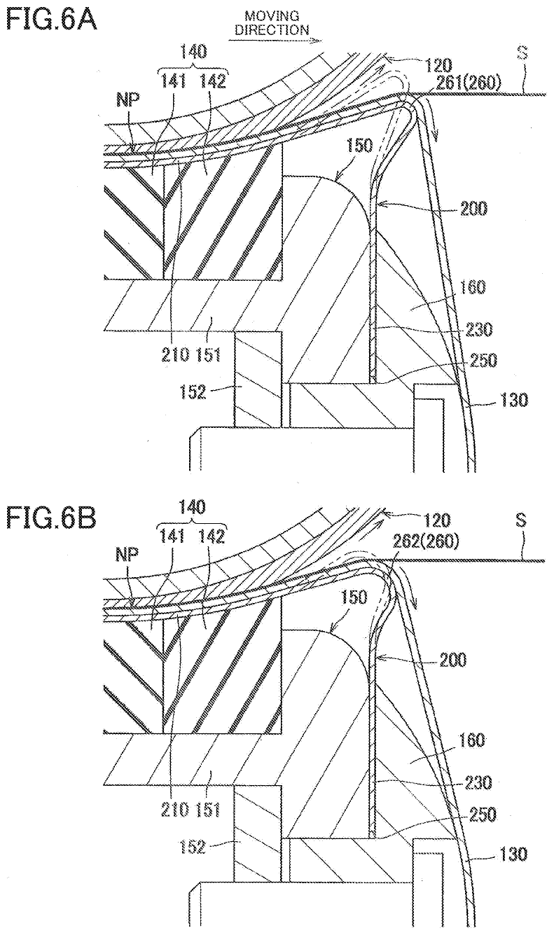

As illustrated in FIGS. 6A, 6B, the sliding sheet 200 is disposed such that the bent portion 260 contacts a portion of the endless belt 130 positioned downstream of the nip portion NP in the moving direction, namely, an inner circumferential surface of the portion of the endless belt 130 protruding from the nip portion NP.

Next, operation and effect of the fixing device 8 according to the embodiment will be explained.

As illustrated in FIGS. 6 A, 6B, when the bent portion 260 contacts the inner circumferential surface of the portion of the endless belt 130 protruding from the nip portion NP, the bent portion 260 elastically bends downward in the moving direction, namely, elastically bends toward a downstream side in the moving direction, thereby biasing the portion of the endless belt 130 protruding from the nip portion NP, namely, the portion of the endless belt 130 passing through the nip portion NP, from an inner side to an outer side of the endless belt 130 by restoring force.

According to the above structure, the portion of the endless belt 130 protruding from the nip portion NP can be pushed out from the inner side to the outer side of the endless belt 130 by the bent portion 260 to thereby give a tension to the endless belt 130. As a result, it is possible to inhibit the portion of the endless belt 130 protruding from the nip portion NP from being unstable because of flapping or the like. Therefore, application of unnecessary stress to the endless belt 130 can be suppressed, and durability of the endless belt 130 can be improved.

In the embodiment, the bent portion 260 extends from one end to the other end of the second portion 220 in the width direction. Accordingly, the tension can be given to the portion of the endless belt 130 protruding from the nip portion NP over the range from one end to the other end of the second portion 220 in the width direction by the bent portion 260.

In the embodiment, the sliding sheet 200 is configured such that the first portion 210 is held between the endless belt 130 and the nip forming member 140 and that the third portion 230 is held between the support member 150 and the facing member 160. Accordingly, the rigidity of the bent portion 260 formed in the second portion 220 between these portions can be secured. As a result, the tension can be positively given to the portion of the endless belt 130 protruding from the nip portion NP by the bent portion 260.

In the embodiment, the rotating member 120 is the concave-shaped roller in which the outer diameters at the both end portions in the width direction are greater than the outer diameter at the center portion as illustrated in FIG. 3. Accordingly, a moving speed at the center portion of in the portion of the endless belt 130 protruding from the nip portion NP is reduced to be lower than a moving speed at both end portions in the portion of the endless belt 130 protruding from the nip portion NP, therefore, the center portion tends to flap. That is, the endless belt 130 tends to be unstable at the center portion in the width direction when coming out from the nip portion NP. However, it is possible to effectively give the tension to the endless belt 130 at the center portion in the width direction by the bent portion 260 according to the embodiment.

Furthermore, the protruding amount of the center bent portion 261 is greater than the protruding amount of the end-part bent portion 262 in the bent portion 260. Therefore, it is possible to positively give the tension to the center portion in the width direction which tends to be unstable in the portion of the endless belt 130 protruding from the nip portion NP by the center bent portion 261.

In a case where the developer image is heat-fixed on the sheet S with a small size such as the sheet S with the B5 size while the rotating member 120 is heated by the heater 110 from one end part of the rotating member 120 to the other end part of the rotating member 120 in the width direction, the outer diameter of the center portion of the endless belt 130 in the width direction becomes small because heat is taken away by the sheet S and the center portion of the endless belt 130 is contracted. Then, the moving speed at the center portion of the endless belt 130 in the width direction is further reduced to be lower than the moving speed at the both end portions of the endless belt 130, and the center portion of the endless belt 130 tends to be unstable when coming out from the nip portion NP. However, the center bent portion 261 as the center portion of the sliding sheet 200 in the width direction extends in the range overlaying the entire area where the sheet S with a small size passes according to the embodiment. Moreover, the center bent portion 261 is disposed between one end and the other end in the width direction of the first heating portion 111A of the first heater 111. Therefore, the tension can be given to the center portion of the endless belt 130 by the bent portion 260 (the center bent portion 261) more effectively.

Additionally, the facing member 160 is the belt guide, therefore, the member for nipping the third portion 230 of the sliding sheet 200 with the support member 150 and the member for guiding the endless belt 130 can be integrally formed. Accordingly, the number of parts of the fixing device 8 can be reduced.

Next, the second embodiment will be explained. In the following description, the same reference signs are assigned to the same components as those in the above-described embodiment, and the explanation thereof is appropriately omitted. Points different from the above-described embodiment will be explained in detail.

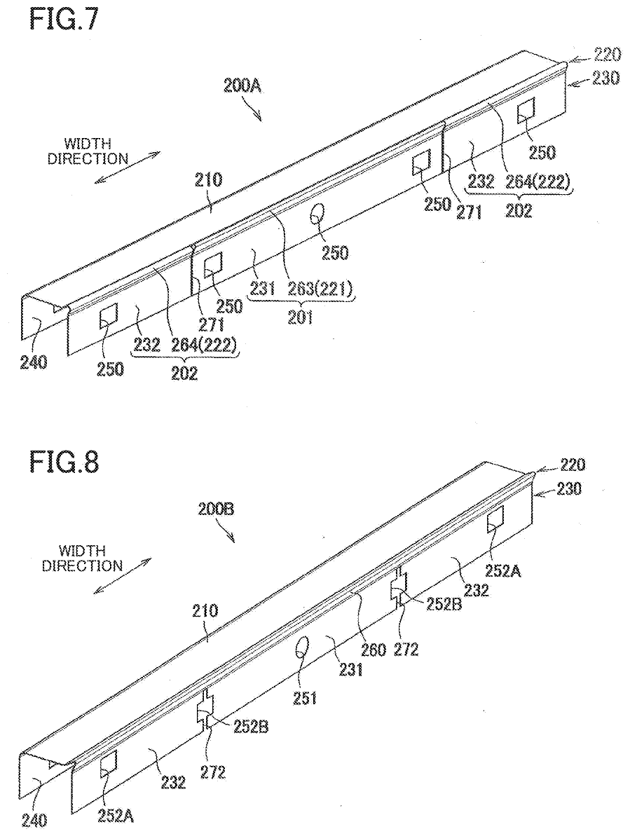

As illustrated in FIG. 7, a sliding sheet 200A includes the first portion 210. The sliding sheet 200A includes the second portion 220. The sliding sheet 200A includes the third portion 230. The sliding sheet 200A includes the fourth portion 240.

In the embodiment, the sliding sheet 200A is configured such that the second portion 220 and the third portion 230 are divided into three by two slits 271 extending in a direction orthogonal in the width direction. Specifically, the sliding sheet 200A is divided into a first piece 201 between the two slits 271 and a pair of second pieces 202 on both sides of the first piece 201 in the width direction by the two slits 271. The first piece 201 includes a second-portion center portion 221 and a third-portion center portion 231. Each of the pair of second pieces 202 includes a second-portion end part 222 and a third-portion end part 232.

The second-portion center portion 221 includes a center bent portion 263. The second-portion end portions 222 include end-part bent portions 264. The center bent portion 263 and the end-part bent portions 264 are portions bent in an approximately U-shape so as to contact the inner circumferential surface of the endless belt 130. Then, a protruding amount of the center bent portion 263 is greater than a protruding amount of the end-part bent portion 264.

According to the above structure, the second portion 220 and the third portion 230 are divided by the two slits 271. Therefore, the protruding amount of the center bent portion 263 is allowed to be different from the protruding amount of the end-part bent portion 264 without performing embossing.

Next, a third embodiment will be explained.

As illustrated in FIG. 8, a sliding sheet 200B includes the first portion 210. The sliding sheet 200B includes the second portion 220. The sliding sheet 200B includes the third portion 230. The sliding sheet 200B includes the fourth portion 240. The second portion 220 has the bent portion 260 extending from one end to the other end in the width direction. In the embodiment, a protruding amount of the bent portion 260 is approximately the same from the one end to the other end in the width direction in a state where the sliding sheet 200B is not assembled to the fixing device 8.

The sliding sheet 200B is configured such that the third portion 230 is divided into three by two slits 272 extending in a direction orthogonal to the width direction. Specifically, the sliding sheet 200B is divided into a first piece 231 between the two slits 272 and a pair of second pieces 232 on both sides of the first piece 231 by the two slits 272.

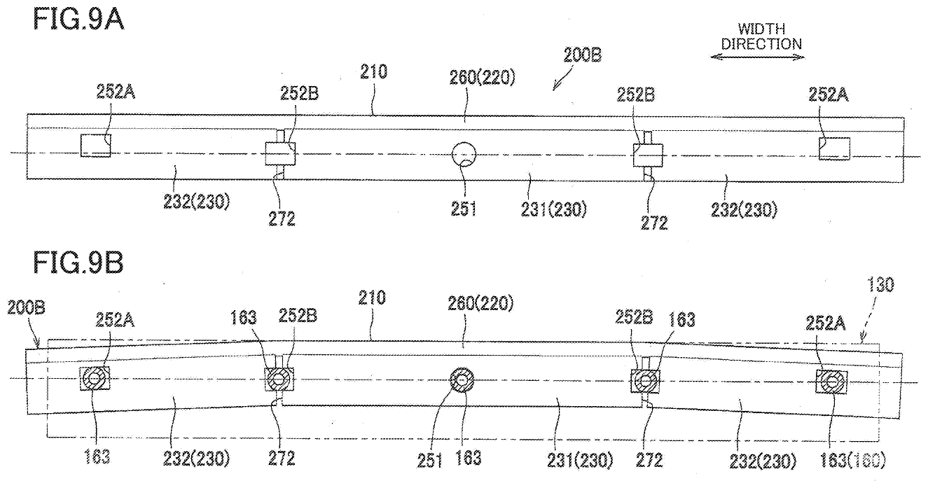

The first piece 231 has a first hole 251 through which one of the protruding portions 163 (see FIG. 9B) of the facing member 160 penetrates. Specifically, the protruding portion 163 disposed at the center in the width direction is engaged with the first hole 251. Each of the pair of second pieces 232 has a second hole 252A through which a corresponding one of the protruding portions 163 penetrates. Specifically, the protruding portions 163 disposed at endmost positions in the width direction are engaged with the second holes 252A. As illustrated in FIG. 9A, the second holes 252A are disposed nearer to the bent portion 260 than the first hole 251 in the direction orthogonal to the width direction. A dimension of each of the second holes 252A in the direction orthogonal to the width direction is approximately the same as a dimension of the first hole 251.

In the third portion 230 of the sliding sheet 200B, third holes 252B that are long in the width direction are respectively formed in the middle of respective slits 272. The protruding portion 163 positioned between the protruding portion 163 disposed at the center in the width direction and the protruding portion 163 disposed at the endmost position is engaged with the third hole 252B. Each of the third holes 252B is disposed at the approximately the same position as the first hole 251 in the direction orthogonal to the width direction. A dimension of each of the third holes 252B in the width direction and in the direction orthogonal to the width direction is approximately the same as a dimension of each of the second holes 252A.

When the above sliding sheet 200B is disposed along the support member 150 (see FIG. 2), and the facing member 160 is attached so as to nip the third portion 230 between the facing member 160 and the support member 150, each of the plurality of protruding portions 163 provided in the facing member 160 so as to be aligned in parallel in the width direction is engaged with a corresponding one of the holes 251, 252A, and 252B as illustrated in FIG. 9B. Then, the second holds 252A are disposed nearer to the bent portion 260 than the first hole 251, therefore, portions on outer sides of the slits 272 in the width direction of the second portion 220 and the third portion 230 can be bent in the direction away from the not-illustrated rotating member (lower direction in FIG. 9B).

According to the above, both end portions of the bent portion 260 can be separated from the inner circumferential surface of the endless belt 130 as compared with the center portion when the sliding sheet 200B is assembled. As a result, the center portion of the bent portion 260 abuts on the inner circumferential surface of the endless belt 130 strongly as compared with both end portions, which can positively give the tension to the center portion of the portion of the endless belt 130 in the width direction protruding from the nip portion NP by the bent portion 260.

In the second embodiment and the third embodiment, the slits 271, 272 may be inclined so as to make an angle, for example, equal to or lower than 45 degrees with respect to the direction orthogonal to the width direction. That is, the slits 271, 272 may extend in a direction crossing the width direction. The slits 271, 272 may have a curved shape, not a straight-line shape.

Next, a fourth embodiment will be explained.

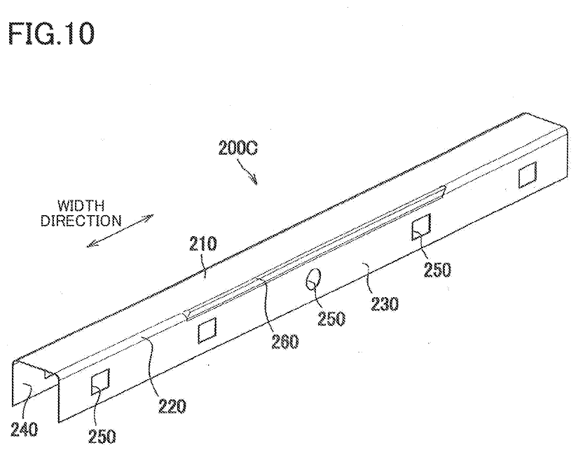

As illustrated in FIG. 10, a sliding sheet 200C includes the first portion 210. The sliding sheet 200C includes the second portion 220. The second portion 220 includes the bent portion 260. The sliding sheet 200C includes the third portion 230. The sliding sheet 200C includes the fourth portion 240. In the embodiment, the bent portion 260 is disposed only in a center portion of the second portion 220 in the width direction. That is, only the center portion of the second portion 220 in the width direction contacts the inner circumferential surface of the endless belt 130, and both end portions of the second portion 220 in the width direction do not contact the inner circumferential surface of the endless belt 130.

According to the above structure, the tension can be given to the center portion in the width direction of the portion of the endless belt 130 protruding from the nip portion NP by the bent portion 260 disposed at the center portion of the second portion 220 in the width direction.

Next, a fifth embodiment will be explained.

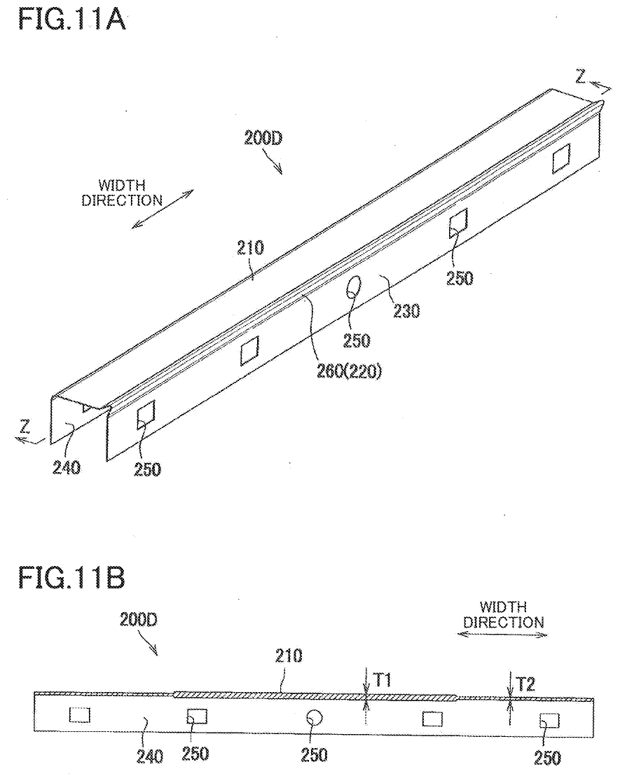

As illustrated in FIG. 11A, a sliding sheet 200D includes the first portion 210. The sliding sheet 200D includes the second portion 220. The second portion 220 has the bent portion 260 extending from one end to the other end of the second portion in the width direction. The sliding sheet 200D includes the third portion 230. The sliding sheet 200D includes the fourth portion 240. In the embodiment, a protruding amount of a portion of the bent portion 260 is approximately equal from one end to the other end of the bent portion in the width direction. As illustrated in FIG. 11B, a thickness T1 at a center portion of the sliding sheet 200 in the width direction is greater than a thickness T2 at both end portions of the sliding sheet 200 in the width direction.

According to the above structure, rigidity at the center portion of the sliding sheet 200D in the width direction including the center portion of the bent portion 260 in the width direction can be higher than rigidity at both end portions. Accordingly, the tension can be positively given to the center portion in the width direction of the portion of the endless belt 130 protruding from the nip portion NP by the portion of the bent portion 260 with higher rigidity formed by the portion with large thickness in the sliding sheet 200D.

The thickness of the sliding sheet is approximately uniform in the first embodiment to the fourth embodiment, however, it is possible to allow the thickness at the center portion in the width direction of the sliding sheet to be greater than the thickness at both end portions in the structures according to the first embodiment to the fourth embodiment. According to this structure, the tension can be positively given to the center portion of the portion of the endless belt 130 in the width direction protruding from the nip portion NP by the bent portion 260.

The embodiments of the disclosure have been explained above, and the present disclosure is not limited to the above embodiments. Specific structures may be appropriately altered within a scope not departing from the gist of the disclosure.

For example, in the structure according to the first embodiment, the protruding amount of the bent portion may be approximately equal from one end to the other end of the bent portion in the width direction.

The protruding amount of the center bent portion 261 is approximately equal in the width direction in the above embodiment, however, the protruding amount is not limited to this. The protruding amount of the center bent portion 261 may be different in the width direction. For example, the protruding amount of the center bent portion 261 may be gradually increased from an end toward the center in the width direction of the center bent portion 261, or may be gradually increased from the center toward the end in the width direction of the center bent portion 261. The same applies to the end-part bent portion 262.

The sliding sheet 200 includes the third portion 230 in the above embodiments, the sliding sheet is not limited to this. A structure not having the third portion 230 may be adopted. The shape and the number of the holes 250 formed in the sliding sheet 200 are not particularly limited. For example, the hole 252 may be an oval shape elongated in the width direction.

The facing member 160 includes the protruding portions 163 protruding toward the support member 150, and the support member 150 includes the holder holes 151C with which the protruding portions 163 are engaged in the above embodiment, however, the structure is not limited to this. For example, the support member may include protruding portions protruding toward the facing member. In this case, the facing member may include through holes or bottomed holes with which the protruding portions are engaged. The number and the shape of the protruding portions are not particularly limited. For example, the protruding portion may have a solid boss shape, not the cylindrical shape. Moreover, the present disclosure may adopt a structure not having any protruding portion.

The facing member 160 is the belt guide for guiding the endless belt 130 in the above embodiment, however, the facing member is not limited to this. For example, the facing member may be a member not having the function of guiding the endless belt. The present disclosure may adopt a structure not having any facing member.

The support member 150 has the holder 151 and the stay 152 in the above embodiment, however, the support member is not limited to this. For example, a member in which the holder 151 and the stay 152 in the above embodiment are integrally formed may be adopted.

The nip forming member 140 has the two elastic bodies 141, 142 in the above embodiment, however, the nip forming member is not limited to this. For example, the nip forming member may have a structure including one elastic body.

The rotating member 120 has the concave shape in the above embodiment, however, the shape of the rotating member is not particularly limited. Moreover, the rotating member 120 is a cylindrical roller in the above embodiment, however, the rotating member 120 is not limited to this. For example, the rotating member may be an endless belt or the like. That is, the fixing device according to the disclosure may have a structure including the endless belt and a second endless belt as the rotating member.

The heater 110 has the first heater 111 and the second heater 112 in the above embodiment, however, the heater is not limited to this. For example, one heater may be provided. Moreover, the halogen lamp utilizing radiant heat is cited as an example of the heater 110 in the above embodiment, however, the heater is not limited to this. For example, a ceramic heater or a carbon heater utilizing heat generation of a resistor may be adopted. The heater may be an IH heater or the like inductively heating the rotating member. The heater may be disposed outside the rotating member, not inside the rotating member.

In the above embodiment, the heating unit 81 includes the heater 110 and the rotating member 120, and the pressure unit 82 includes the endless belt 130, the nip forming member 140, the support member 150, the facing member 160, and the sliding sheet 200, however, the structure is not limited to this. For example, the fixing device may have a structure in which the heating unit has the heater, the endless belt, the nip forming member, the support member, the facing member, and the sliding sheet, and the pressure unit has the rotating member. The rotating member in the pressure unit is not limited to the endless belt. For example, a roller including a core metal and an elastic layer covering an outer circumferential surface of the core metal or the like may be used. When the heating unit includes the endless belt, the heater may be disposed inside the endless belt and may be disposed outside the endless belt.

The example in which the fixing device according to the disclosure is applied to the image forming apparatus for forming a monochrome image on the sheet has been explained in the above embodiments, however, the fixing device is not limited to this. For example, the fixing device may be applied to an image forming apparatus capable of forming a colored image on the sheet. The image forming apparatus is not limited to the laser printer. For example, a printer exposing the photoconductor drum by light emitted from an LED may be applicable. The image forming apparatus may be a copying machine or a multifunction machine including a manuscript reader such as a flatbed scanner.

Respective elements explained in the above embodiments and modification examples may be suitably combined to achieve the examples.

What is claimed is:

1. A fixing device comprising:
a heater;
a rotating member heated by the heater;
an endless belt;
a nip forming member forming a nip portion by nipping the endless belt between the nip forming member and the rotating member; and
a sliding sheet including a first portion that is a portion of the sliding sheet nipped between the endless belt and the nip forming member and a second portion extending from a downstream end of the first portion in a moving direction of the endless belt in the nip portion, the sliding sheet having higher flexural rigidity than flexural rigidity of the endless belt,
wherein the second portion includes a bent portion bent so as to contact an inner circumferential surface of the endless belt, and
wherein the bent portion configured to urge, in a direction directed from an inner side toward an outer side of the endless belt, a portion of the endless belt positioned downstream of the nip portion in the moving direction.

2. The fixing device according to claim 1,
wherein the bent portion extends from one end to the other end of the second portion in a width direction of the endless belt.

3. The fixing device according to claim 2,
wherein the bent portion includes a center portion and end portions which interpose the center portion therebetween in the width direction, and a protruding amount of the center portion is greater than a protruding amount of each of the end portions.

4. The fixing device according to claim 2,
wherein the bent portion includes a center portion and end portions which interpose the center portion therebetween in the width direction, and a thickness of the center portion is greater than a thickness of each of the end portions.

5. The fixing device according to claim 3,
wherein the center portion of the bent portion extends in the width direction such that, in the width direction, an entire area at which a sheet with a minimum size passes is overlaid with the center portion of the bent portion, and the sheet with the minimum size is a sheet, a size of which is a minimum size, on which fixing is executable by the fixing device.

6. The fixing device according to claim 3,
wherein the heater includes a first heater having a first heating portion heating a center portion of the rotating member in the width direction and a second heater having a pair of second heating portions heating end portions of the rotating member in the width direction,
wherein a first end of the center portion of the bent portion in the width direction is disposed at a position overlaps both of the first heating portion and one of the second heating portions in the width direction, and
wherein a second end of the center portion of the bent portion in the width direction is disposed at a position overlaps both of the first heating portion and the other of the second heating portions in the width direction.

7. The fixing device according to claim 1,
wherein the bent portion is disposed only at a center portion of the second portion in the width direction of the endless belt.

8. The fixing device according to claim 1,
wherein the rotating member includes a center portion and end portions which interpose the center portion therebetween in a width direction of the endless belt, and the rotating member is a roller in which an outer diameter of each of the end portions is greater than an outer diameter of the center portion.

9. The fixing device according to claim 1, further comprising:
a support member supporting the nip forming member; and
a facing member disposed on the inner side of the endless belt and downstream of the nip portion in the moving direction so as to face the support member,
wherein the sliding sheet includes a third portion extending from the second portion toward a position between the support member and the facing member, and
wherein the third portion is nipped between the support member and the facing member.

10. The fixing device according to claim 9,
wherein the bent portion extends from one end to the other end of the second portion in a width direction of the endless belt,
one of the support member and the facing member comprises a plurality of protruding portions each protruding toward the other of the support member and the facing member, and the plurality of protruding portions are aligned in a direction parallel to the width direction,
wherein the sliding sheet is configured such that the third portion is divided into a first piece and a pair of second pieces by two slits extending in a direction intersecting the width direction, the first piece is interposed between the pair of second piece in the width direction, and
wherein the first piece has a first hole through which a first protruding portion of the plurality of protruding portions penetrates, each of the second pieces has a second hole through which a second protruding portion of the plurality of protruding portions penetrates, and the second hole is nearer to the bent portion than the first hole.

11. The fixing device according to claim 9,
wherein the facing member is a belt guide guiding the endless belt while contacting the inner circumferential surface of the endless belt.

12. The fixing device according to claim 11,
wherein the support member comprises a holder holding the nip forming member and a stay supporting the nip forming member via the holder, and
wherein the third portion is nipped between the belt guide and the holder.

13. The fixing device according to claim 12,
wherein the sliding sheet includes a fourth portion extending from an upstream end of the first portion in the moving direction in a direction away from the rotating member, and
wherein the fourth portion is nipped between the belt guide and the holder.

14. The fixing device according to claim 1,
wherein the sliding sheet is a sheet made of resin containing polyimide.

15. The fixing device according to claim 1,
wherein the rotating member is a cylindrical roller, and
wherein the heater is disposed on an inner side of the roller.

16. The fixing device according to 1,
wherein the nip forming member comprises a first elastic body and a second elastic body harder than the first elastic body, and
wherein the first elastic body is disposed on upstream of the second elastic body in the moving direction.
